(19) United States
(12) Patent Application Publication
(10) Pub. No.: US 2008/0120878 A1
(43) Pub. Date: May 29, 2008

(54) Visual indicia arrangement for an oral apparatus

(75) Inventor: Fred Smith, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Ingenious Concepts, Inc., Allison Park, PA (US)

(21) Appl. No.: 11/715,645

(22) Filed: Mar. 8, 2007

Related U.S. Application Data
(60) Provisional application No. 60/780,658, filed on Mar. 9, 2006.

(51) Int. Cl. G09F 21/02

(52) U.S. Cl. 40/586

(57) ABSTRACT

A visual indicia arrangement for use in an oral apparatus in connection with the teeth of a human, and the apparatus having a front surface. The arrangement includes a visual indicia element, a carrier member for carrying the element and attached to the front surface of the oral apparatus, and an attaching arrangement for attaching the carrier member to the front surface of the oral apparatus. The oral apparatus may be a retainer device, a mouth guard or braces. The visual indicia element may be a letter, a number, a symbol, a character, a colored surface or even coated with a fluorescent or other reflective material. The visual indicia arrangement may make wearing the oral apparatus fun to wear, and several arrangements may be used to form a sentence or convey an expression. Several different types of visual indicia arrangements and methods for constructing the arrangements are also provided.

### CROSS REFERENCE TO RELATED APPLICATION

This application claims the benefit of U.S. Provisional Patent Application No. 60/780,658 filed Mar. 9, 2006.

### BACKGROUND OF THE INVENTION

1. Field of Invention

The present invention relates generally to an oral apparatus such as a retainer device used to adjust and/or maintain corrected teeth and a mouth guard used to protect the teeth during physical activities. More particularly, the present invention is directed to visual indicia arrangements for use by humans in connection with retainer devices, mouth guards and the like.

2. Description of the Prior Art

In the field of dentistry and orthodontics, braces are used to assist in adjusting the angle and displacement of human teeth. As the technology of manufacturing and applying braces to human teeth develops, the market and class of targeted patients increase. Both children and adults of all ages may wear braces for some length of time to straighten their teeth for aesthetic reasons. Additionally, braces may also be worn to correct and/or prevent medical mishaps resulting from improperly placed or growing teeth in the human mouth. Often, during a period after or in lieu of wearing braces, the patient may wear a retainer device. Such retainer devices are often worn at night while the patient is sleeping and similar to braces are positioned and designed to adjust or prevent movement of the patient's teeth. Since many retainer devices are made of transparent material, the patient is encouraged to wear these devices as often as possible in order to maximize the effects of using a retainer.

As alluded to, in order to eliminate or reduce the metallic appearance of the retainer device in the mouth, transparent or partially transparent retainer devices have been developed. While the patient may enjoy the results that wearing braces and/or retainer devices may bring, many patients, especially children, do not like the appearance of these devices in their mouths even though they may be transparent or almost transparent and therefore hardly noticeable. While these new transparent or partially transparent retainer devices are an improvement over the metallic devices, some patients may not mind wearing a retainer device that is more noticeable if it is fun to wear. Users of mouth guards and the like may also be more prone to wearing these oral apparatuses or devices if they were more fun to wear.

Therefore, there is a need to provide oral apparatuses, such as retainer devices, mouth guards and the like, having a quality and appearance which makes them fun to wear.

### SUMMARY OF THE INVENTION

The present invention has met these needs. The present invention provides a visual indicia arrangement for use in an oral apparatus comprising a visual indicia element, a carrier member for supporting the visual indicia element and attached to at least the front surface of the oral apparatus, and an attaching arrangement for attaching the carrier member to the front surface of the oral apparatus. The visual indicia may be a letter, a number, a symbol, a character, a design, a colored surface, or the visual indicia may be coated with a fluorescent or other reflective material. Several visual indicia may be used to express one's self. For example, several visual indicia arrangements, each containing a visual indicia element such as a letter, may be used to convey a message which becomes visible when the user of the oral apparatus opens his or her mouth.

The present invention also provides for methods for constructing a visual indicia arrangement. One such method includes the steps of attaching a spacing box to the front surface of a mold of the teeth, placing a first transparent retainer material over the mold of the tooth and the spacing box, allowing the first retainer material to form the shape of the mold of the teeth and the spacing box which becomes a formed box for receiving the carrier member and the visual indicia element, removing the first retainer material from the shape of the mold of the teeth and the spacing box, and removing a top portion of the formed box for the insertion of the carrier member and the visual indicia element.

A further method for constructing a visual indicia arrangement includes the steps of providing a first transparent retainer material and a spacing box on the front surface of a mold of the teeth, placing a second transparent retainer material over the first transparent retainer material and the spacing box and allowing the spacing box to be permanently attached to the first transparent retainer material allowing the first transparent retainer material and the second transparent retainer material to form the shape of the teeth and the spacing box, removing the first retainer material and the second transparent retainer material from the mold of the teeth which are now in the shape of the teeth and still contains the spacing box, and removing a top portion of the second transparent retainer material to allow access into the spacing box for the insertion of the carrier member and the visual indicia element.

The present invention includes an attaching arrangement in operational communication with or otherwise integral with an oral apparatus, such as a retainer device or mouth guard, for use in connection with a user's teeth. In one preferred and non-limiting embodiment, the attaching arrangement is integral with or formed with the retainer device or mouth guard. A carrier member for carrying and supporting a visual indicia element comprises or is in operational communication with such a visual indicia element. In use, the carrier member is attached to the retainer via the attaching arrangement such that the visual indicia element being carried by the carrier member is visible to others when the user or wearer opens his or her mouth.

These and other features and characteristics of the present invention will become more apparent upon consideration of the following description with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1a is a plan view of a retainer device of the prior art as applied to a person's teeth;

FIG. 1b is a side view of a tooth and the retainer device of FIG. 1a;

FIG. 2 is a side view of a tooth and a retainer and includes a schematic of the visual indicia arrangement of the present invention;

FIG. 3a is a front view of an embodiment of an attaching arrangement of the present invention;

FIG. 3b is a side view of the attaching arrangement of FIG. 3a together with a visual indicia carrier member and a visual indicia element of the present invention;

FIG. 4a is a front view of another embodiment of an attaching arrangement of the present invention;

FIG. 4b is a side view of the attaching arrangement of FIG. 4a together with a visual indicia carrier member and a visual indicia element of the present invention;

FIG. 5a is a front view of a further embodiment of an attaching arrangement of the present invention;

FIG. 5b is a side view of the attaching arrangement of FIG. 5a together with a visual indicia carrier member and a visual indicia element of the present invention;

FIG. 6a is a front view of a still further embodiment of an attaching arrangement of the present invention;

FIG. 6b is a side view of the attaching arrangement of FIG. 6a together with a visual indicia carrier member and a visual indicia element of the present invention;

FIG. 7a is a front view of a further embodiment of an attaching arrangement of the present invention;

FIG. 7b is a side view of the attaching arrangement of FIG. 7a together with a visual indicia carrier member and a visual indicia element of the present invention;

FIGS. 8a-8c are side views illustrating a method for constructing a visual indicia arrangement in connection with a retainer device according to the teachings of the present invention; and

FIGS. 9a-9c are side views illustrating a further method for constructing a visual indicia arrangement in connection with a retainer device according to the teachings of the present invention.

### DETAILED DESCRIPTION OF THE INVENTION

As used in the specification, the singular form of “a”, “an”, and “the” include plural referents unless the context clearly dictates otherwise. For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific arrangements, devices and methods illustrated in the attached drawings and disclosed herein are exemplary embodiments of the invention. Therefore, specific dimensions and other physical characteristics related to the embodiments of the invention as disclosed herein are not to be considered as limiting.

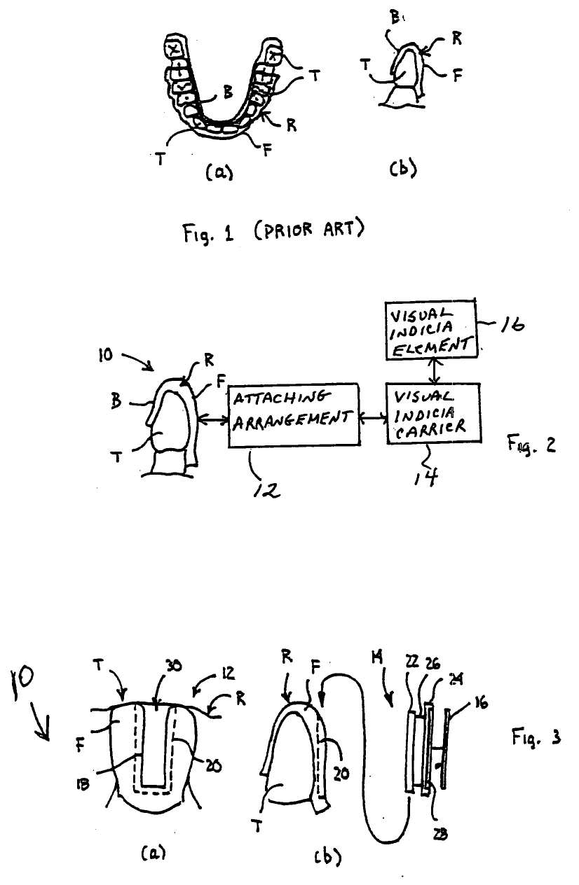

As illustrated in FIGS. 1a and 1b and as is known in the art, a person often wears a retainer device R. This retainer R is specifically manufactured for placement over the person's teeth T, whether it is the top row of the person's teeth T and/or the bottom row of the person's teeth T. Also, as is known in the art, the retainer R may be made from a transparent, yet rigid, plastic material that is molded to fit the contours and arrangement of the person's teeth T. For use, the person simply places or slides the retainer R over the teeth T and wears it for a prescribed amount of time in order to obtain the therapeutic and correctional advantages.

The retainer R typically contacts both the rear and front surfaces of the person's teeth T. Accordingly, the retainer device R includes a back surface B and a front surface F. The front surface F provides an area of the retainer R on the front surface of each of the teeth T for use in connection with the present invention.

The present invention is directed to a visual indicia arrangement for use in an oral apparatus, e.g., a retainer device or a mouth guard, in connection with one or more teeth. Several such visual indicia arrangements may be used and spread across the teeth to convey a message or an expression. Various embodiments of such a visual indicia arrangement are illustrated at 10 in FIGS. 2-7c, and at least two different methods for constructing the visual indicia arrangement in connection with teeth are illustrated in FIGS. 8 and 9.

FIG. 2 schematically illustrates the visual indicia arrangement 10 attached to the front surface F of the retainer R positioned on the teeth T. Visual indicia arrangement 10 is attached to retainer R via an attaching arrangement 12, more about which will be discussed hereinbelow, and arrangement 10 further includes a carrier member 14 for carrying and supporting a visual indicia element, and a visual indicia element 16. In general, the visual indicia element 16 is carried by the carrier member 14, which is attached to retainer R via attaching arrangement 12, and, in particular, the visual indicia arrangement 10 includes the attaching arrangement 12 that is in operational communication with or integral with the front surface F of the retainer R.

As discussed hereinbelow, in one preferred and non-limiting embodiment, the attaching arrangement 12 is constructed or manufactured as part of the retainer R. For example, since the retainer R is often manufactured by molding plastic over a mold of the person's teeth T, the attaching arrangement 12 may be constructed during this process. The carrier member 14 includes or is in operational communication with the visual indicia element 16. The visual indicia may be a letter, a number, a symbol, a character, a design, a colored surface, or the visual indicia may be coated with a fluorescent or other reflective material. Such indicia may be used in creating expressions in the person's mouth. In use, the carrier member 14 is attached to the retainer R via the attaching arrangement 12 such that the visual indicia element 16 is visible to others when the person opens his or her mouth.

As stated hereinabove, various arrangements are envisioned for attaching the visual indicia carrier member 14 and/or the visual indicia element 16 to the retainer R via the attaching arrangement 12. For example, as illustrated in FIGS. 3a and 3b, the retainer R may be manufactured with a substantially vertical slot 18 forming a recess 20. In this embodiment, the visual indicia carrier member 14 includes a rim 22, which is sized and shaped or configured to mate with the recess 20. In addition, the rim 22 is attached to a carrier substrate 24 by a neck portion 26. The neck portion 26 is sized and shaped or configured to slide along and within the slot 18 to secure the carrier member 14 within slot 18 and, therefore, in recess 20. The carrier substrate 24 includes a recess 28 for receiving and carrying the visual indicia element 16.

In operation, the visual indicia element 16 is attached to the carrier substrate 24 by positioning the visual indicia element 16 within the recess 28 formed on the carrier substrate 24. In order to attach both the carrier member 14 and the visual indicia element 16 to the retainer R, the rim 22 of visual indicia carrier 14 is aligned with recess 20, and the neck portion 26 is aligned with the slot 18 formed on the retainer R. Next, both the rim 22 and neck portion 26 are slid into the respective recess 20 and slot 18 through an opening 30. In this manner, the carrier member 14 with the visual indicia element 16 is removably attached within the attaching arrangement 12 of the retainer R.

A further embodiment is illustrated in FIGS. 4a and 41). In this embodiment, the retainer R is manufactured with an integral box 32 having an inner area 34, an opening 36 and a front surface 38. Preferably the front surface 38 has a portion made of a transparent material. In addition, the carrier member 14 and the visual indicia element 16 are integrally constructed or manufactured as a single component in a manner apparent to one skilled in the art. In operation, the carrier member 14 and the visual indicia element 16 are configured to be slidably inserted as a unit into the box 32 through the opening 36 of box 32. In doing this, both the visual indicia carrier member 14 and the visual indicia element 16 are supported in box 32 with the visual indicia element 16 visible through the transparent front surface 38 of the box 32. It is to be appreciated that various portions or even the entire front surface 38 may be removed for additional clarity and visibility of the visual indicia element 16.

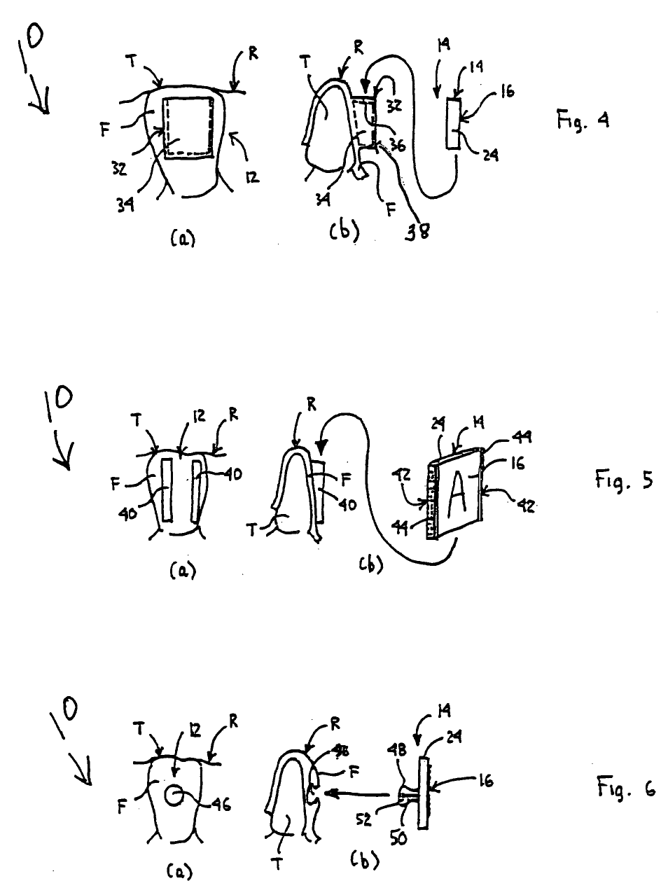

A further embodiment is illustrated in FIGS. 5a and 5b. In this embodiment, retainer R is constructed or manufactured with two mutually opposing projections 40 which form an opening on the front surface F of the retainer R, which is mounted on teeth T. Similar to the embodiment of FIGS. 4a and 4b, the carrier member 14 and the visual indicia element 16 are manufactured as a unit. As shown in FIG. 5b, carrier member 14 has opposing edges 42 which are comprised of or coated with a flexible material 44, such as a flexible plastic, polymer, sponge and cellular material. This flexible material 44 on the opposed edges 42 engage the projections 40 when the carrier member 14 and visual indicia element 16 are inserted into the slot form by opposing projections 40. Specifically, when carrier member 14 and visual indicia element 16 are inserted between opposing projections 40, the flexible material 44 along the opposing edges 42 of the visual indicia carrier 14 compresses and frictionally engages the projections 40. In this manner, the carrier member 14 and, therefore, the visual indicia element 16 are removably attached to the retainer R.

Yet another embodiment is illustrated in FIGS. 6a and 6b. In this embodiment, the retainer R, and in particular the front surface F of the retainer R, is constructed with a cavity 46. The carrier member 14 supports the visual indicia element 16 through means which have already been disclosed herein or through means which are apparent to those skilled in the art. Carrier member 14 also includes a compressible projection 48. The compressible projection 48 is sized and shaped or configured to be appropriately and frictionally received within the cavity 46 of the attaching arrangement 12. In operation, the carrier member 14 is pressed against the retainer R, causing the compressible projection 48 to be compressed and forced into cavity 46. After insertion into cavity 46, the compressible projection 48 expands to its normal shape to secure the carrier member 14, and therefore, the visual indicia element 16 is in place against the front surface F of the retainer R.

In the embodiment of FIGS. 6a and 6b, the compressible projection 48 may be button-shaped or some other shape that can easily be received within the cavity 46. Also, the compressible projection 48 may be made of any compressible material that is capable of expanding to its original shape after compression. In order to provide additional rigidity to the compressible projection 48, a pin 50 may be inserted to extend longitudinally within an inner area 52 of compressible projection 48. The use of pin 50 would not adversely affect the compressible characteristics of the compressible projection 48, but would add to the structural integrity of the projection 48 for its use in attaching the carrier member 14 and the visual indicia element 16 to retainer R.

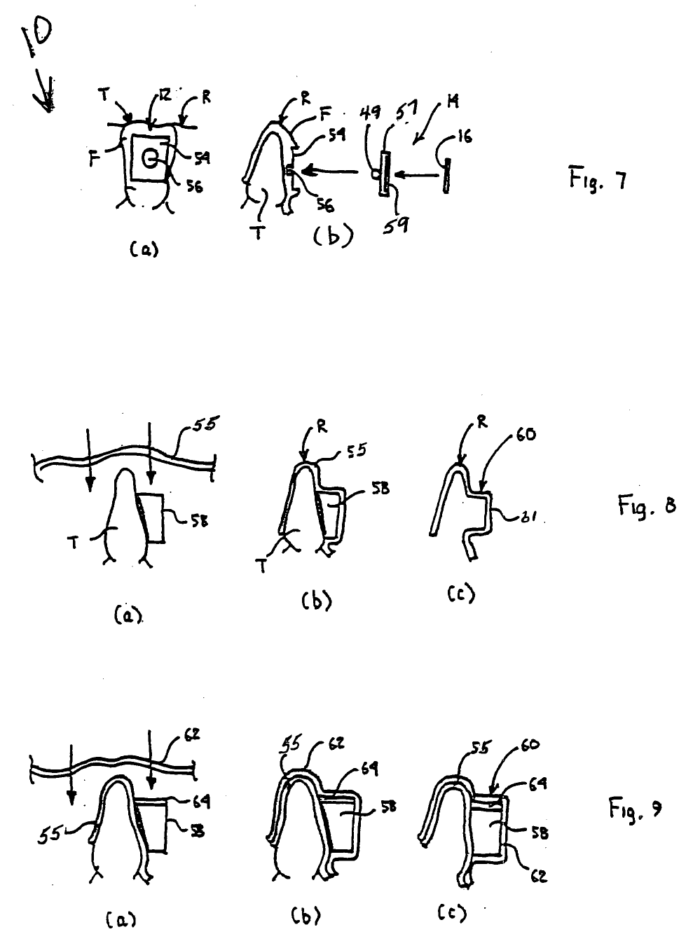

The embodiment of FIGS. 7a and 7b has an attaching arrangement 12 that includes a recess 54 and a cavity 56 formed on the front surface F of the retainer R, and a compressible member 49 on carrier member 14. The cavity 56 and the compressible member 49 are similar in construction and operation to that of cavity 46 and compressible member 48 of the embodiment of FIGS. 6a and 6b. The carrier recess 54 is sized and shaped or configured to receive a carrier substrate 57 of carrier member 14, and carrier substrate 57 has a recess 59 for receiving and carrying the visual indicia element 16. In operation, the visual indicia element 16 is positioned within the recess 59 of carrier substrate 57. The carrier member 14, along with the visual indicia element 16, is attached within the recess 54 by forcing the compressible projection 49 into cavity 56. Further, due to the use of the carrier recess 54, the entire visual indicia of the embodiment of FIGS. 7a and 7b is substantially flush with the front surface F of the retainer R.

As can be appreciated from the above discussion of the present invention, different visual indicia arrangements 10 of the invention are envisioned. The visual indicia arrangement 10 of the several embodiments of the invention would allow the user to attach the visual indicia element 16 to the retainer R via the carrier member 14 and attaching arrangement 12. In addition, the arrangement 10 allows for the easy removal of the visual indicia element 16 such that a letter, number or design may be interchanged to change the overall message. By using a visual indicia arrangement 10 on each of the teeth T and corresponding retainer R portion, any number of messages and expressions can be created by the user.

The construction of the visual indicia arrangements 10 of the invention has the advantage that the user can easily remove and insert a visual indicia element or elements 16 himself or herself without the need of professional help. Accordingly, this allows the user to modify the expression or message on the retainer R. As discussed hereinabove, the visual indicia arrangement 10 is equally useful in connection with mouth guards for displaying messages and other expressions, for example, to an opposing team.

FIGS. 8a-8c illustrate a method for constructing a visual indicia arrangement of the invention. As shown in FIG. 8a, a first retainer material 55 is applied over both the mold of the teeth T as well as a spacing box 58 which is attached to a front surface of the mold of the teeth T. The material 55 preferably is a transparent material that forms and creates a rigid mold of the teeth T. As shown in FIG. 8b, the retainer material 55 covers a tooth T of the mold of the teeth and the spacing box 58. As shown in FIG. 8c, after the retainer material 55 is shaped into a desired form, it is removed from the mold and the spacing box 58, resulting in a retainer with a formed box 61. A top portion 60 of the area created by the spacing box 58 is removed, thereby allowing for the insertion of the carrier member 14 with visual indicia element 16 in the formed box 61 of the visual indicia arrangement of the invention. This method may be used for constructing the visual indicia arrangement 10 of FIGS. 4a and 4b.

A further method for constructing a visual indicia arrangement of the invention is shown in FIGS. 9a-9c. In this instance, the first retainer material 55 is already placed over and formed to the mold of the teeth T. Next, the spacing box 58 is attached to the retainer material 55. Next, as shown in FIG. 9a, a second retainer material 62 is placed over the first retainer material 55 and spacing box 58. Accordingly, as shown in FIG. 9b, the second retainer material 62 covers the spacing box 58 and the first retainer material 55. Finally, as shown in FIG. 9c, the spacing box 58 is not removed but instead is permanently attached to the first retainer material 55 and within the second retainer material 62. As FIG. 9c shows, the first retainer material 55 the spacing box 58 and the second retainer material 62 are removed from the tooth mold as a unit still retaining its shape. The top portion 60 of the second retainer material 62 is removed to provide access to the spacing box 58.

Particularly referring to FIG. 9c, the spacing box 58 includes a lid 64 which may be hinged. Lid 64 allows easy access into the spacing box 58 and allows the user to retain the visual indicia element 16 within spacing box 58. This type of attaching arrangement 12 would be most beneficial when using the visual indicia arrangement of the invention in a retainer R for the top row of teeth T. In particular, lid 64 would prevent the visual indicia element 16 from sliding out of the spacing box 58 and therefore out of the mouth of the wearer.

As can be appreciated, the present invention may decrease or eliminate the unsightliness and/or self-consciousness that typically accompany the use of oral apparatuses, such as retainers R, especially in children. In addition, the present invention allows for the decoration and expression of one's self through the use of different visual indicia elements 16 in the retainer R. Further, the present invention allows the user to express himself or herself and change that expression as often as he or she desires. Even though the indicia elements may be configured as being changeable, i.e., easily inserted or attached to the carrier member 14, it is also envisioned that the arrangement 10 of the invention may be manufactured with a predetermined message or expression which is fixed in the carrier members 14, i.e., not readily removable or changeable relative to the carrier members 14.

The visual indicia element 16 may be a letter, a number, a symbol, a character, a colored surface or even coated with a fluorescent or other reflective material. Still further, it is envisioned that appropriate mechanisms can be used for lighting up portions of the visual indicia arrangement 10, such as the visual indicia element 16, the carrier member 14 and/or the attaching arrangement 12. Also, in some instances, the visual indicia element or elements 16 may be configured to be programmable via a computer. Any such variations are understood to be within the context of the present invention.

Although the invention has been described in detail for the purpose of illustration based on what is currently considered to be the most practical and preferred embodiments, it is to be understood that such detail is solely for that purpose and that the invention is not limited to the disclosed embodiments, but on the contrary, is intended to cover modifications and equivalent arrangements that are within the spirit and scope of this disclosure. For example, it is to be understood that the present invention contemplates that, to the extent possible, one or more features of any embodiment can be combined with one or more features of any other embodiment. Additionally, as stated hereinabove, the oral apparatuses in which the visual indicia arrangements of the invention may be used also include mouth guards and braces.

The invention claimed is:

1. A visual indicia arrangement for use in an oral apparatus in connection with at least one tooth of a human, the oral apparatus having at least a front surface, and the visual indicia arrangement comprising:
a visual indicia element,
a carrier member for supporting the visual indicia element and attached to at least the front surface of the oral apparatus, and
an attaching arrangement for attaching the carrier member to the front surface of the oral apparatus.

2. The visual indicia arrangement of claim 1, wherein the oral apparatus is a retainer device.

3. The visual indicia arrangement of claim 1, wherein the oral apparatus is a mouth guard.

4. The visual indicia arrangement of claim 1, wherein the attaching arrangement includes a slot forming a recess located on the front surface of the oral apparatus, and
wherein the carrier member comprises:
a rim configured to be in alignment with and slidable in the recess,
a neck portion connected to the rim and configured to be in alignment with and slidable in the slot of the attaching arrangement, and
a carrier substrate connected to the neck portion and having a recess for receiving the visual indicia element.

5. The visual indicia arrangement of claim 1, wherein the attaching arrangement includes a box located on the front surface of the oral apparatus,
wherein the box has an opening and a transparent front surface,
wherein the carrier member and the visual indicia element are integrally formed and configured to be slidably inserted into and supported in the box of the attaching arrangement, and
wherein the visual indicia element is visible through the transparent front surface of the box of the attaching arrangement.

6. The visual indicia arrangement of claim 1, wherein the attaching arrangement includes two opposing projections located on the front surface of the oral apparatus and forming an opening,
wherein the carrier member and the visual indicia element are integrally formed and configured to be slidably inserted into the opening formed by the two opposing projections and supported therein,
wherein the carrier member has opposing edges comprised of a flexible material for frictional engagement with the opposing projections, and
wherein when the carrier member and the visual indicia element are inserted into the opening formed by the two opposing projections, the flexible material of the carrier member compresses for frictional engagement with the opposing projections.

7. The visual indicia arrangement of claim 1, wherein the attaching arrangement includes a cavity formed in the front surface of the oral apparatus and a compressible projection formed on the carrier member, and
wherein the compressible projection formed on the carrier member is configured to be frictionally received in the cavity formed in the front surface of the oral apparatus.

8. The visual indicia arrangement of claim 8, wherein the compressible projection includes a pin extending longitudinally through the compressible projection for rigidity.

9. The visual indicia arrangement of claim 1, wherein the attaching arrangement includes a cavity formed on the front surface of the oral apparatus, a recess surrounding the cavity and a compressible project formed on the carrier member,
wherein the compressible projection formed on the carrier member is configured to be frictionally received in the cavity formed in the front surface of the oral apparatus,
wherein the carrier member includes a recess for receiving the visual indicia element, and
wherein the carrier member is configured to be received and supported in the recess surrounding the cavity formed on the front surface of the oral apparatus.

10. A method for constructing the visual indicia arrangement of claim 1, the steps comprising:
attaching a spacing box to the front surface of a mold of the teeth,
placing a first transparent retainer material over the mold of the teeth and the spacing box,
allowing the first retainer material to form the shape of the mold of the teeth and the spacing box and to form a box for receiving the carrier member and the visual indicia element,
removing the first retainer material from the shape of the mold of the teeth and the spacing box, and
removing a top portion of the formed box for the insertion of the carrier member and the visual indicia element.

11. A method for constructing a visual indicia arrangement of claim 1, the steps comprising:
providing a first transparent retainer material and a spacing box on the front surface of a mold of the teeth,
placing a second transparent retainer material over the first transparent retainer material and the spacing box and allowing the spacing box to be permanently attached to the first transparent retainer material,
allowing the first retainer material and the second transparent retainer material to form the shape of the mold of the teeth and the spacing box,
removing the first retainer material and the second transparent retainer material from the shape of the mold of the teeth, and
removing a top portion of the second transparent retainer material to allow access into the spacing box for the insertion of the carrier member and the visual indicia element.
